(19) United States
(12) Patent Application Publication
(10) Pub. No.: US 2011/0197718 A1
(43) Pub. Date: Aug. 18, 2011

(54) MULTI-WRENCH APPARATUS AND METHOD OF USE

(76) Inventor: David Meholovitch, Glendora, CA (US)

(21) Appl. No.: 12/773,678

(22) Filed: May 4, 2010

Related U.S. Application Data
(63) Continuation-in-part of application No. 12/705,814, filed on Feb. 15, 2010.

(51) Int. Cl. B25B 13/46; B25B 13/06; B25B 23/00

(52) U.S. Cl. 81/60; 81/121.1; 81/124.5

(57) ABSTRACT

An assembly for handling a work piece may include a handle and a drive member coupled to the handle. The drive member may include a body that is rotatably coupled to the handle and at least one socket coupled to the body. The socket includes a ratchet mechanism that is operable to enable and disable rotation of the body and the handle relative to the socket while the socket is engaged with the work piece.

### CROSS-REFERENCE TO RELATED APPLICATIONS

This application is a continuation-in-part of U.S. patent application Ser. No. 12/705,814, which was filed on Feb. 15, 2010, the disclosure of which is hereby incorporated by reference in its entirety.

### BACKGROUND OF THE INVENTION

1. Field of the Invention

Embodiments of the invention include a wrench assembly configured to engage and transfer torque to work pieces of various shapes and sizes. Embodiments of the invention include a wrench assembly having rotatable and replaceable drive members for selectively engaging work pieces of various shapes and sizes. Embodiments of the invention include a wrench assembly having a splined socket configuration that is operable to engage work pieces having different shaped and sized engagement surfaces. Embodiments of the invention include an assembly that is operable to engage and transmit torque to a work piece upon rotation thereof in a first direction and operable to prevent the transmission of torque to the work piece upon rotation thereof in an opposite direction without having to disengage from the work piece. Embodiments of the invention include an assembly for handling a work piece having a drive member with a body and at least one socket coupled to the body, such that the socket includes a ratchet mechanism that is operable to enable and disable rotation of the body and relative to the socket while the socket is engaged with the work piece.

2. Description of the Related Art

Numerous tools have been developed in the past to rotatably drive work pieces, such as bolts, nuts, and the like, in different types of work environments. Common wrenches, adjustable wrenches, and socket wrenches are just a few examples of the tools used to handle work pieces. These wrenches help provide the mechanical advantage necessary to form or remove a connection using a work piece. In a typical work environment, a person may need to handle numerous work pieces of different shapes and sizes, including damaged work pieces, to form or remove various connections. It may thus be necessary to have multiple tools available to work with these work piece connections, which increases the amount of equipment required to complete a job. In addition to the variety of work pieces, the physical work location may be confined to a small working area and/or the work pieces may be located in a confined space. It may thus be further necessary to have more tools available to handle the work pieces within these spatial limitations. Having several tools in a small work environment may cause disorganization, and having to search for a specific tool to handle each work piece can be extremely time-consuming.

Therefore, there is a need for a universal apparatus that is configured to handle various types, shapes, and sizes of work pieces, which thereby reduces the need to have multiple tools and pieces of equipment to handle the same work pieces effectively. There is a further need for an apparatus that can be used easily in confined spaces and configured to engage various types, shapes, and sizes of work pieces in confined spaces. There is a further need still for an improved apparatus that is durable, compact, easy to use, and provides the flexibility and versatility to handle assorted work pieces in any type of work environment.

### SUMMARY OF THE INVENTION

Embodiments of the invention include a wrench assembly and a method of use. In one embodiment, a wrench assembly for handling one or more work pieces may include a handle, a first drive member connected to a first end of the handle, and a second drive member connected to a second end of the handle. The first and second drive members may each have a plurality of drives configured to engage and transmit torque to one or more work pieces.

In one embodiment, a wrench assembly for transferring torque to one or more work pieces may include a handle and a first drive member connected to the handle. The first drive member may include a spline configuration operable to engage work pieces having different shapes of engagement surfaces.

In one embodiment, a method of handling a work piece using a wrench assembly may include providing a wrench assembly having a first drive member with a spline configuration that is configured to engage work pieces having different shapes of engagement surfaces. The method may further include engaging one or more of the work pieces with the drive member and transmitting torque to the work piece by applying a force to the wrench assembly.

In one embodiment, an assembly for handling a work piece may include a handle and a drive member. The drive member may have a body that is coupled to the handle and a plurality of sockets that are coupled to the body. Each socket may include a ratchet mechanism that is operable to enable rotation of the body and the handle relative to each socket in a first rotational direction.

In one embodiment, an assembly for handling a work piece may include a handle and a drive member. The drive member may have a body coupled to the handle and a socket coupled to the body. The body may be rotatable about a first axis that is perpendicular to a longitudinal axis of the handle. And the body and the handle may be rotatable about a central axis of the socket. The central axis of each socket may be perpendicular to the first axis.

In one embodiment, an assembly for handling a work piece may include a handle and a drive member. The drive member may have a body that is rotatably coupled to the handle and a plurality of sockets that are coupled to the body. Each socket may include a ratchet mechanism. The ratchet mechanism may be operable to secure the handle, the body, and the socket together upon rotation thereof in a first direction about the work piece to transmit torque to the work piece. The ratchet mechanism may also be operable to enable the handle and the body to rotate relative to the socket upon rotation thereof in a second direction about the work piece to prevent the transmission of torque to the workpiece while the socket is engaged with the workpiece. The first direction may be a clockwise direction and the second direction may be a counterclockwise direction.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a wrench assembly according to one embodiment of the invention.

FIGS. 2A-2F illustrate a sectional view of a socket of the wrench assembly engaging one or more work pieces according to embodiments of the invention.

FIGS. 3A-3B illustrate the wrench assembly and sockets according to one embodiment of the invention.

FIGS. 4 and 5 illustrate the wrench assembly according to embodiments of the invention.

FIGS. 6 and 7 illustrate the wrench assembly sockets according to embodiments of the invention.

FIG. 8 illustrates the wrench assembly according to embodiments of the invention.

### DETAILED DESCRIPTION

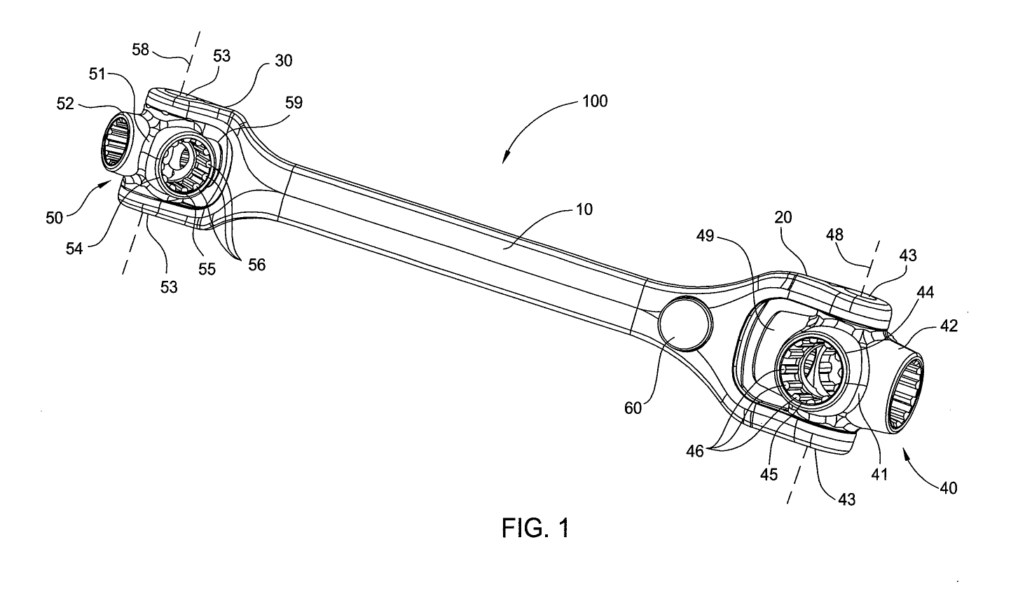

FIG. 1 illustrates a wrench assembly 100 according to one embodiment. The wrench assembly 100 is configured to engage multiple sizes and shapes of work pieces, such as bolts, nuts, screws, and the like. The wrench assembly 100 includes a handle 10, a first wrench end 20, a second wrench end 30, a first drive member 40, a second drive member 50, and an optional gripping mechanism 60. The components of the wrench assembly 100 may be formed from a variety of materials, including metal and metal alloys. In one embodiment, one or more components of the wrench assembly 100 may be formed from steel, such as chrome-moly steel.

The handle 10 includes a rectangular shaped body configured to be easily gripped by a user for handling of the wrench assembly 100. The first and second wrench ends 20 and 30 are located at opposite ends of the handle 10. The wrench ends 20 and 30 each include a pair of arms that extend from the handle 10, thereby forming a substantially “Y” or “U” shaped configuration. In one embodiment, the handle 10 and the wrench ends 20 and 30 may be formed from a single piece of material. In an alternative embodiment, the wrench ends 20 and 30 may be connected to the handle 10 in a number of ways know to one of ordinary skill, including a welded connection, a releasable connection, etc.

The wrench ends 20 and 30 are configured to support the first and second drive members 40 and 50, respectively. The drive members 40 and 50 are pivotably connected to the arms of each wrench end one or more pins 43 and 53 that extend through the sides of each arm and the drive members so that the drive members are rotatable relative to the handle 10. The drive members 40 and 50 may be connected to the wrench ends in a number of ways known to one of ordinary skill, including various bearing connections and/or releasable connections, etc. The drive members 40 and 50 may also be secured to the wrench ends 20 and 30 with a locking member, such as a pin and groove arrangement, which allows the drive members to be secured in a specific angular position relative to the handle 10. The locking member prevents uncontrolled rotation of the drive members 40 and 50 relative to the handle 10, such as by gravitational forces, and allows a controlled 360 degree positioning of the drive members during use of the wrenching assembly 100.

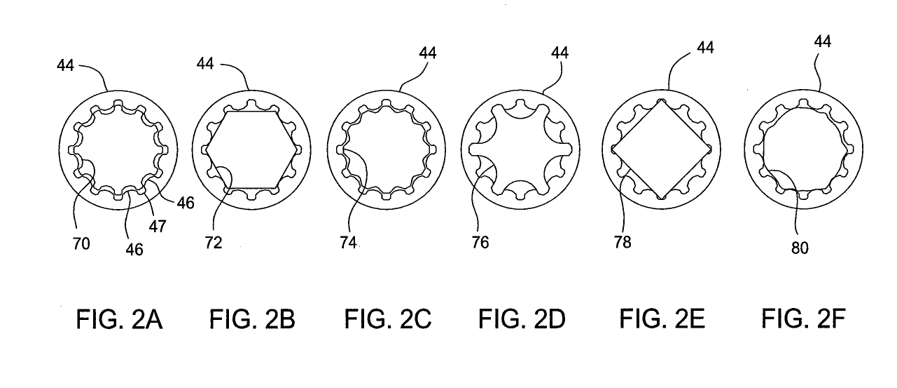

Although the following description recites features of the first drive member 40, the description similarly applies to the second drive member 50. Corresponding components of the second drive member have “50” series reference numerals. The first drive member 40 includes a body 41 having one or more sockets extending outward from the body. In one embodiment, the first drive member 40 includes four cylindrical shaped sockets that are symmetrically positioned about the body of the drive member. FIG. 1 illustrates three sockets 42, 44, and 49, with a fourth socket positioned on the opposite side of the body 41 from the socket 44, similar to the opposing sockets 42 and 49. The sockets may extend from the body at about a 90 degree angle from a central axis 48 of the body. Each socket has a central opening 45 so that opposing sockets, 42 and 49 for example, form a bore disposed through the body 41 of the first drive member 40. The sockets also include one or more splines 46 for engaging a work piece. As further illustrated in FIG. 2A, each spline 46 may be separated by a space, such as a groove 47, along the inner surface of the socket 44. In one embodiment, each socket includes twelve splines 46. In one embodiment, the splines 46 are symmetrically located around the central opening 45 of the socket and extend substantially the longitudinal length of each socket. In one embodiment, the ends of the splines 46 may be rounded or may have beveled edges to facilitate ease of insertion of the work piece into the socket. Each spline 46 may include a cylindrical shaped body, a rectangular shaped body having rounded edges, or any other shape configured to engage a workpiece and facilitate the transfer of torque to the work piece. In one embodiment, the body 41 of the drive member 40 and the splines 46 may be formed from a single piece of material. In one embodiment, splines 46, individually or as a group, may be secured to the inner surface of the body 41 of the drive member 40 in any manner known by one of ordinary skill, such as by weld, thread, etc. Various other socket configurations, splined or otherwise, may be used such that an individual socket is adapted to engage multiple shapes of work pieces and transfer torque thereto.

The splined configuration of each socket is adapted to engage multiple shapes of work pieces. FIGS. 2A-2F illustrate various work piece shapes that can be engaged using the splined configuration embodiment of the invention. FIGS. 2A-2F illustrates a cross-sectional view of the individual socket 44 of the first drive member 40 engaging several different work pieces 70, 72, 74, 76, 78, and 80. The socket 44 is configured to engage and transfer torque to the work pieces 70, 72, 74, 76, 78, and 80. In one embodiment, the work pieces shown in FIGS. 2A-2F may be bolts having a spline shaped bolt head, a 6-point bolt head, a 12-point bolt head, a star shaped bolt head, a square shaped bolt head, or a damaged or worn bolt head, respectively. In one embodiment, the work pieces shown in FIGS. 2A-2F may be nuts having the respective shapes described above.

In addition to the multiple shapes of work pieces that one socket may engage, the remaining sockets may each have a different diameter, thereby compounding the number, type, size, and shape of work pieces that the wrench assembly 100 may be used to handle. In one embodiment, one or more of the sockets may include a metric socket size of 8 mm, 10 mm, 11 mm, 13 mm, 14 mm, 16 mm, 17 mm, and 19 mm. In one embodiment, one or more of the sockets may include an SAE socket size of 5/16″, ⅜″, 7/16″, ½″, 9/16″, ⅝″, 11/16″, and ¾″. In one embodiment, the wrench assembly 100 may include other socket sizes known by one of ordinary skill. In one embodiment, the wrench assembly 100 may include the first drive member 40 having one or more splined sockets of varying diameters, and the second drive member 50 having one or more splined sockets of varying diameters that are greater than, less than, or equal to one or more of the sockets of the first drive member 40. The wrench assembly 100 and the wrench ends 20 and 30 may be adapted to support various combinations of socket sizes for each drive member.

The gripping mechanism 60 may be configured to hold one or more work pieces and/or secure the wrench assembly 100 to a work surface. In one embodiment, the gripping mechanism is a magnet. The magnet may hold one or more metallic work pieces, such as nuts, and/or secure the wrench assembly 100 to a metallic surface during non-use.

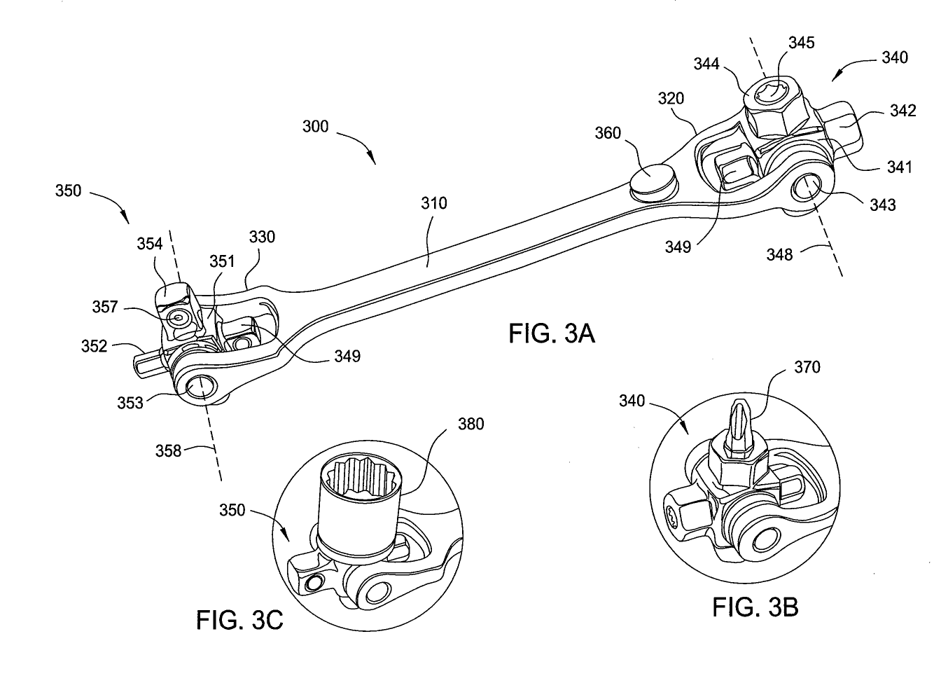

FIG. 3A illustrates a wrench assembly 300 according to one embodiment. The description of the wrench assembly 100 above similarly applies to the wrench assembly 300. Corresponding components of the wrench assembly 300 have “300” series reference numerals. The wrench assembly 300 includes a handle 310, a first wrench end 320, a second wrench end 330, a first drive member 340, a second drive member 350, and an optional gripping mechanism 360. The handle 310, the first and second wrench ends 320 and 330, the first and second drive members 340 and 350, and the gripping member 360 may be similarly configured relative to each other as the wrench assembly 100. The components of the wrench assembly 300 may be formed from a variety of materials, including metal and metal alloys. In one embodiment, one or more components of the wrench assembly 300 may be formed from steel, such as chrome-moly steel.

The first drive member 340 includes a body 341 having one or more bit drivers extending outward from the body. In one embodiment, the first drive member 340 includes four hexagonal and/or cylindrical shaped bit drivers that are symmetrically positioned about the body of the drive member. FIG. 3A illustrates three bit drivers 342, 344, and 349, with a fourth bit driver positioned on the opposite side of the body 341 from the bit driver 344, similar to the opposing bit drivers 342 and 349. The bit drivers may extend from the body at about a 90 degree angle from a central axis 348 of the body. Each bit driver has a central opening 345 adapted to receive one or more bits for engaging a work piece. In one embodiment, the central opening 345 includes a hexagonal shape and extends substantially the longitudinal length of the bit driver. In one embodiment, the edges of the central opening 345 may be rounded or may have beveled edges to facilitate ease of insertion of a bit into the bit driver. The bit driver may include any other shape configured to engage a workpiece with a bit and facilitate the transfer of torque to the work piece. Various other bit driver configurations may be used such that an individual bit driver is adapted to receive multiple sizes and shapes of bits and thus engage multiple sizes and shapes of work pieces.

The second drive member 350 includes a body 351 having one or more socket drivers extending outward from the body. In one embodiment, the second drive member 350 includes four square shaped socket drivers that are symmetrically positioned about the body of the drive member. FIG. 3A illustrates three socket drivers 352, 354, and 359, with a fourth socket driver positioned on the opposite side of the body 351 from the socket driver 354, similar to the opposing socket drivers 352 and 359. The socket drivers may extend from the body at about a 90 degree angle from a central axis 358 of the body. Each socket driver has a driving element 357 adapted to receive and temporarily secure one or more sockets for engaging a work piece. In one embodiment, the driving element 357 includes a square shaped arm that extends substantially the longitudinal length of the socket driver, and a spring loaded ball detent secured in the arm. In one embodiment, the edges of the driving element 357 may be rounded or may have beveled edges to facilitate ease of insertion of a socket onto the socket driver. The socket driver may include any other design configured to engage a workpiece with a socket and facilitate the transfer of torque to the work piece. Various other socket driver configurations may be used such that an individual socket driver is adapted to receive multiple sizes and shapes of sockets and thus engage multiple sizes and shapes of work pieces.

FIGS. 3B and 3C illustrate the first and second drive members 340 and 350, respectively. FIG. 3B illustrates a bit 370 secured to a bit driver of the first drive member 340. FIG. 3C illustrates a socket 380 secured to a socket driver of the second drive member 350. In one embodiment, the socket 380 secured to the second drive member 350 may include the splined configuration of the wrench assembly 100 described above.

In addition to the multiple shapes of bits and sockets that one bit driver or socket driver may engage, the remaining bit or socket drivers may each have a different size and/or shape, thereby compounding the number, type, size, and shape of bits and sockets and thus work pieces that the wrench assembly 300 may be used to handle. In one embodiment, one or more of the bit drivers may be configured to receive and secure drive bit sizes/shapes including ¼″ and ⅜″ drive bits having 5 mm, 7 mm, 10 mm Slotted, #2 Phillips, #3 Phillips, T10 Torx, T20 Torx and 7 mm and 12 mm Hex Bits. In one embodiment, one or more of the socket drivers may be configured to receive and secure sockets having a metric socket size of 8 mm, 10 mm, 11 mm, 12 mm, 13 mm, 14 mm, 16 mm, 17 mm, and 19 mm, and/or an SAE socket size of 5/16″, ⅜″, 7/16″, ½″, 9/16″, ⅝″, 11/16″, and ¾″. In one embodiment, the wrench assembly 300 may be configured for use with other bits and sockets known by one of ordinary skill. In one embodiment, the wrench assembly 300 may include the first drive member 340 having one or more bit drivers of varying shapes and sizes, and the second drive member 350 having one or more socket drivers of varying shapes and sizes. In one embodiment, the first drive member 340 and/or the second drive member 350 may each include a combination of one or more bit drivers connected with one or more socket drivers. The wrench assembly 300 and the wrench ends 320 and 330 may be adapted to support various combinations of bit and socket drives for each drive member.

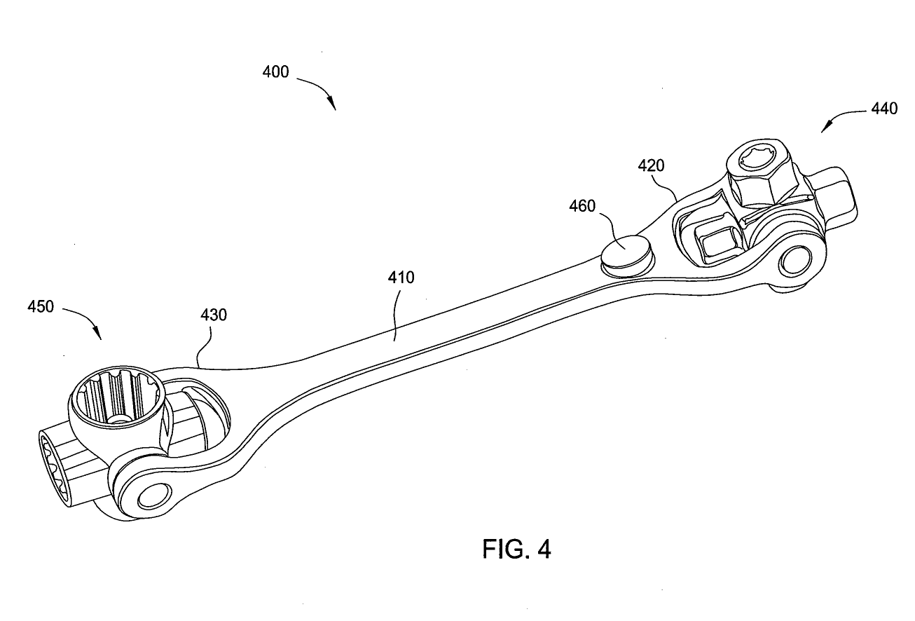

FIG. 4 illustrates a wrench assembly 400 according to one embodiment. The descriptions of the wrench assemblies 100 and 300 above similarly apply to the wrench assembly 400. Corresponding components of the wrench assembly 400 have “400” series reference numerals. The wrench assembly 400 includes a combination the wrench assemblies 100 and 300. As illustrated, the wrench assembly 400 includes a first drive member 440, which is the same component as the drive member 40 of the wrench assembly 100. The wrench assembly 400 also includes a second drive member 450, which is the same component as the drive member 340 of the wrench assembly 300. The wrench assembly 400 and the wrench ends 420 and 430 may be adapted to support various combinations of drive members described herein.

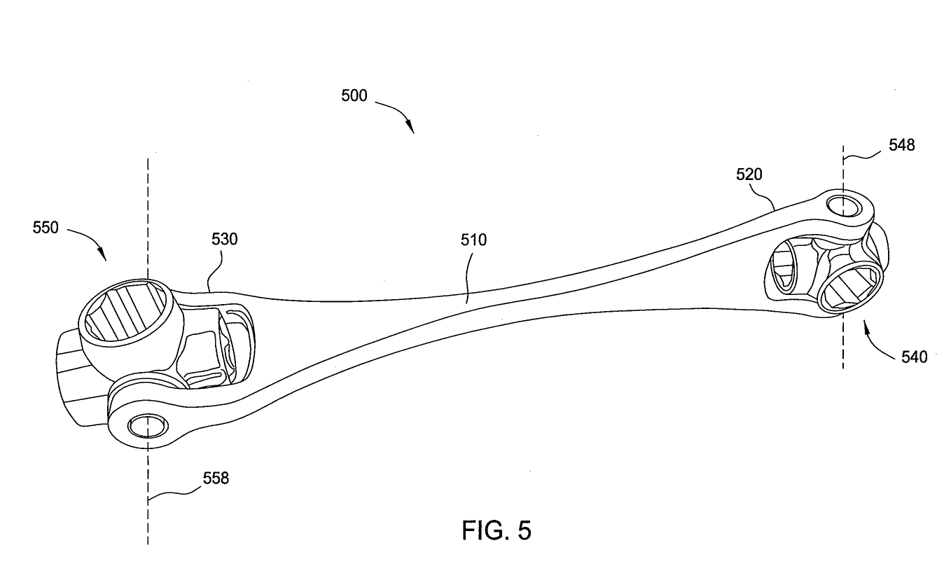

FIG. 5 illustrates a wrench assembly 500 according to one embodiment. The descriptions of the wrench assemblies 100, 300, and 400 above similarly apply to the wrench assembly 500. Corresponding components of the wrench assembly 500 have “500” series reference numerals. The wrench assembly 500 includes a handle 510, a first wrench end 520, a second wrench end 530, and first and second drive members 540 and 550. As illustrated, the wrench ends 520 and 530 are “twisted” relative to each other and extend from the handle 510 in opposite directions. The pair of arms of the first wrench end 520 are offset at an angle, a 90 degree angle for example, from the pair of arms of the second wrench end 530. In one embodiment, the transverse axis of the first wrench end 520 is located at a 90 degree angle relative to the transverse axis of the second wrench end 530. The handle 510 and the wrench ends 520 and 530 may be positioned relative to each other at various other angular configurations. The first and second drive members 540 and 550 may include one or more combinations of the drive members described herein. In one embodiment, the first and second drive members 540 and 550 each include four hexagonal sockets of varying diameters that are rotatably connected to the wrench ends.

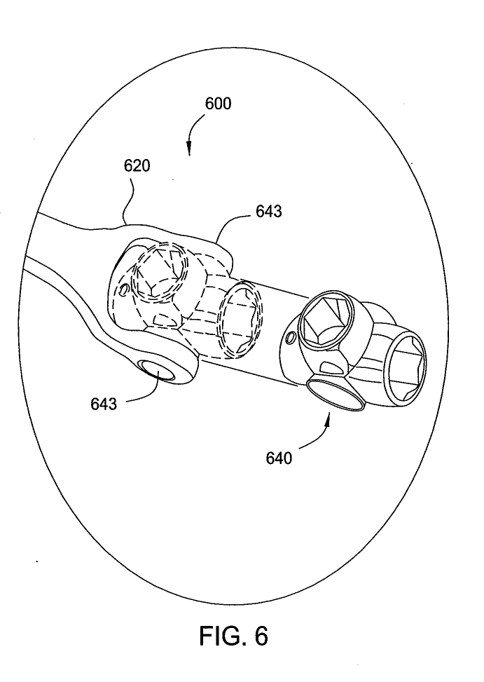

FIG. 6 illustrates a drive member 640 releaseably connected to a wrench end 620 of a wrench assembly 600. The descriptions of the wrench assemblies 100, 300, 400, and 500 above similarly apply to the wrench assembly 600. Corresponding components of the wrench assembly 600 have “600” series reference numerals. As illustrated, the drive member 640 may be released from the wrench end 620 by applying force to one or more of the pins 643 used to couple the drive member 640 to the wrench end 620. In one embodiment, the drive member 640 may be connected to and released from the wrench end 620 by a spring-loaded mechanism for quick connect and disconnect with the wrench assembly 600. Any type of connection known to one of ordinary skill may be used to releaseably connect the drive member 640 to the wrench end 620. In this manner, the wrench assembly 600 may be configured with changeable drive members on one or both of the wrench ends. The various drive members described herein may be releasably connected to any one of the wrench assemblies disclosed above.

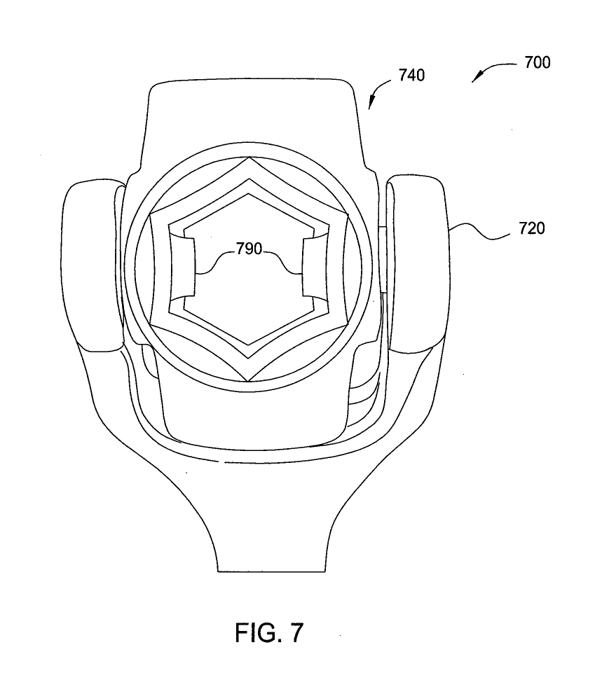

FIG. 7 illustrates a drive member 740 connected to a wrench end 720 of a wrench assembly 700. The descriptions of the wrench assemblies 100, 300, 400, 500, and 600 above similarly apply to the wrench assembly 700. Corresponding components of the wrench assembly 700 have “700” series reference numerals. As illustrated, the drive member 740 may include one or more gripping mechanisms 790 disposed on the inner surface of the bore of the drive member 740. In one embodiment, the gripping mechanism 790 may be a magnet configured to help secure the engagement between the wrench assembly 700 and the work piece being handled by the wrench assembly 700. Any type of gripping mechanism known to one of ordinary skill may be used to help secure connection between the wrench assembly and the work piece during use. The various drive members described herein may include similar gripping mechanisms, such as magnets, disposed on their inner surfaces to facilitate use of the wrench assemblies.

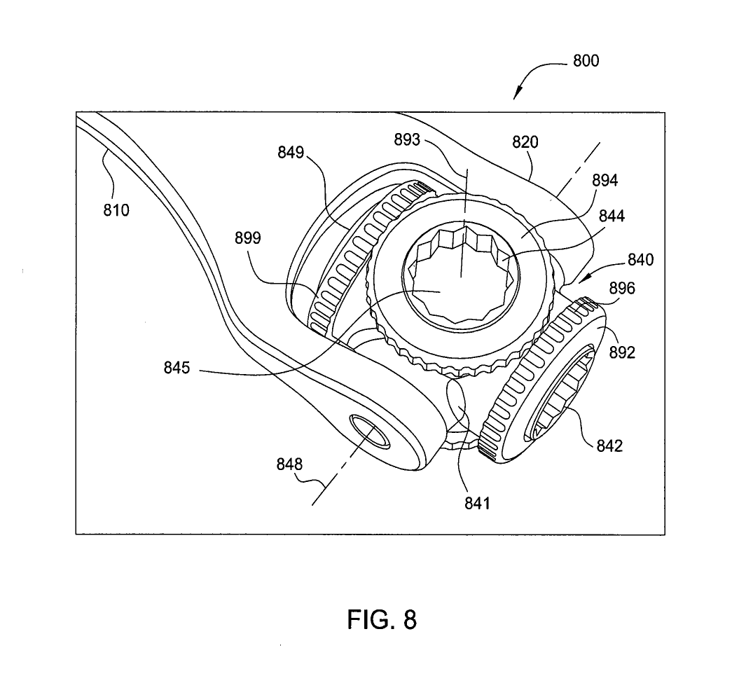

FIG. 8 illustrates a drive member 840 connected to a wrench end 820 and handle 810 of a wrench assembly 800. Although only one end of the wrench assembly 800 is shown, the opposite end may also include a drive member as described herein. The descriptions of the wrench assemblies 100, 300, 400, 500, 600, and 700 above similarly apply to the wrench assembly 800. Corresponding components of the wrench assembly 800 have “800” series reference numerals. All possible combinations of the various wrench assembly (100, 300, 400, 500, 600, 700, and 800) components are contemplated within the embodiments of the invention.

As illustrated in FIG. 8, the drive member 840 includes a body 841 having one or more sockets that extend outward from the body 841 and that are adapted to engage one or more work pieces. In one embodiment, each socket may include an engagement surface for engaging a work piece, and a cylindrical body that is coupled to the body 841 of the drive member 840. In one embodiment, the drive member 840 includes four sockets that are symmetrically positioned about the body 841 of the drive member 840. FIG. 8 illustrates three sockets 842, 844, and 849, with a fourth socket positioned on the opposite side of the body 841 from the socket 844, similar to the opposing sockets 842 and 849. The sockets may extend from the body 841 at about a 90 degree angle from a central axis 848 of the body 841. The drive member 480 is rotatable about the central axis 848 of the body 841 and relative to the wrench end 820 and handle 810. The central axis 848 is generally perpendicular to a longitudinal axis of the handle 810. In one embodiment, each socket has a central opening 845 so that opposing sockets, 842 and 849 for example, form a bore disposed through the body 841 of the drive member 840. In one embodiment, the central opening 845 may be closed so that there is no bore disposed through the body 841 of the drive member 840.

As further illustrated in FIG. 8, each socket 842, 844, 849 has a ratchet mechanism 892, 894, 899, that is operable to allow continuous rotational motion of the wrench end 820 and handle 810 relative to a central axis of each socket, such as central axis 893 of socket 844, while preventing relative rotational motion in the opposite direction. The wrench end 820 and handle 810 (and thus the body 841 which is coupled to the wrench end 820) may rotate relative to the each socket 842, 844, 849. In this manner, each socket 842, 844, 849 may engage and transfer torque to a work piece via the handle 810, without requiring that the socket be removed from and re-engaged to the work piece after each turn of the wrench handle 810.

In one embodiment, each ratchet mechanism 892, 894, 899 may include one or more gears with teeth, and one or more control members (also known as a “pawl”) that engage the gear teeth. The control member may be configured to allow free rotation of the gear in a first direction, and restrict rotation of the gear in a second, opposite direction. For example, the control member may pivotably secured to a surface adjacent to the gear at one end, and may be biased into engagement with the gear teeth at the other end. The biased end of the control member may slide over a sloped surface of each gear tooth as it moves relative to the control member in a first direction. The control member end, however, may engage a sharp edge of one of the sloped surfaces as the gear moves in an opposite direction, thereby preventing any further movement in the opposite direction. Other ratchet mechanisms known by one of ordinary skill in the art may be used.

In one embodiment, each ratchet mechanism 892, 894, 899 may include a switch 896, such as a knob, that is operable to enable and disable the ratchet mechanism. For example, the switch 896 may engage or disengage one or more control members with one or more gears of the ratchet mechanism, the one or more control members pivotably secured to the body 841 and biased into engagement with one or more gears secured to the sockets. The switch 896 may be operable to allow each socket 842, 844, 849 to transmit torque to a work piece via a clockwise and/or counterclockwise rotation of the handle 810. The switch 896 may be operable to secure the ratchet mechanisms in a first and/or second locked position, so that the sockets 842, 844, 849, the body 841, and the handle 810 are locked together to transmit torque to the work piece by turning the handle 810 in a clockwise direction, while permitting the body 841 and the handle 810 to freely rotate relative to the sockets 842, 844, 849 in a counter clockwise direction, and vice versa. In one embodiment, the switch 896 may be operable to secure the ratchet mechanism in a neutral position that allows each socket 842, 844, 849 to freely rotate relative to the body 481, the wrench end 820, and/or the handle 810 in both a clockwise and counterclockwise direction, and vice versa. Other switch-type mechanisms known by one of ordinary skill in the art may be used. In one embodiment, the wrench assembly 800 may include a spring loaded ball detent mechanism that is operable to secure the body 841 relative to the wrench end 820 to position the sockets at various angular positions during use.

In one embodiment, one or more of the sockets 842, 844, 849 may include the same socket configurations as those described above with respect to FIGS. 1, 2A-2F, 3A-3B, and 4-7, including a splined configuration, a hexagonal configuration, a square configuration, etc. In one embodiment, one or more of the sockets 842, 844, 849 may include the same socket sizes as those described above with respect to FIGS. 1, 2A-2F, 3A-3B, and 4-7. In one embodiment, the sockets 842, 844, 849 may be in the form of socket drivers that are configured to receive one or more sockets for engaging a work piece. In one embodiment, the sockets 842, 844, 849 may be in the form of bit drivers that are configured to receive one or more bits for engaging a work piece. Various other socket configurations, sizes, and combinations of sockets may be used.

While the foregoing is directed to embodiments of the invention, other and further embodiments of the invention may be devised without departing from the basic scope thereof, and the scope thereof is determined by the claims that follow.

1. An assembly for handling a work piece, comprising:
a handle; and
a drive member having a body and a plurality of sockets coupled to the body, wherein the body is coupled to the handle, and wherein each socket includes a ratchet mechanism that is operable to enable rotation of the body and the handle relative to each socket in a first rotational direction.

2. The assembly of claim 1, wherein the ratchet mechanism is operable to prevent rotation of the body and handle relative to the socket in a second rotational direction that is opposite the first rotational direction.

3. The assembly of claim 2, wherein at least one socket is operable to engage the work piece and transmit torque to the work piece upon rotation of the body and the handle in the second rotational direction.

4. The assembly of claim 3, wherein the ratchet mechanism of the at least one socket is operable prevent the transmission of torque to the work piece upon rotation of the body and the handle in the first rotational direction, while the at least one socket is engaged with the work piece.

5. The assembly of claim 4, wherein the body and the handle are rotatable in the first rotational direction and the second rotational direction about a central axis of each socket.

6. The assembly of claim 5, wherein the first rotational direction is a counterclockwise direction and the second rotational direction is a clockwise direction.

7. The assembly of claim 1, wherein the body is rotatably coupled to the handle.

8. The assembly of claim 1, wherein at least one of the sockets is a different size than one of the other sockets.

9. The assembly of claim 1, wherein at least one of the sockets is configured to engage and transmit torque to a plurality of work pieces that have different shapes of engagement surfaces.

10. The assembly of claim 1, wherein at least two of the plurality of sockets extend from the body in opposite directions.

11. The assembly of claim 1, wherein the drive member includes four sockets symmetrically extending from the body at about 90 degree angles.

12. The assembly of claim 1, wherein each socket includes at least one of a splined configuration, a hexagonal configuration, and a square configuration.

13. An assembly for handling a work piece, comprising:
a handle; and
a drive member having a body coupled to the handle and a socket coupled to the body, wherein the body is rotatable about a first axis that is perpendicular to a longitudinal axis of the handle, and wherein the body and the handle are rotatable about a central axis of the socket, which is perpendicular to the first axis.

14. The assembly of claim 13, wherein socket includes a ratchet mechanism that is operable to enable rotation of the body and the handle relative to the socket in a first rotational direction about the central axis of the socket.

15. The assembly of claim 14, wherein the ratchet mechanism is operable to prevent rotation of the body and handle relative to the socket in a second rotational direction that is opposite the first rotational direction.

16. The assembly of claim 15, wherein the ratchet mechanism is operable to enable rotation of the body and handle relative to the socket in both the first and second rotational directions.

17. The assembly of claim 15, wherein the first rotational direction is a counterclockwise direction and the second rotational direction is a clockwise direction.

18. The assembly of claim 13, wherein the drive member includes a plurality of sockets coupled to the body, and wherein the body and the handle are rotatable about a central axis of each socket, which is perpendicular to the first axis.

19. An assembly for handling a work piece, comprising:
a handle; and
a drive member having a body that is rotatably coupled to the handle and a plurality of sockets coupled to the body, wherein each socket includes a ratchet mechanism that is operable secure the handle, the body, and the socket together upon rotation thereof in a first direction about the work piece to transmit torque to the work piece, and wherein the ratchet mechanism is operable to enable the handle and the body to rotate relative to the socket upon rotation thereof in a second direction about the work piece to prevent the transmission of torque to the workpiece while the socket is engaged with the workpiece.

20. The assembly of claim 19, wherein the first direction is a clockwise direction and the second direction is a counterclockwise direction.
